(19) United States
(12) Patent Application Publication
(10) Pub. No.: US 2008/0263037 A1
(43) Pub. Date: Oct. 23, 2008

(54) METHOD AND APPARATUS FOR INDICATING CONTENT SEARCH RESULTS

(75) Inventors: Jun Jie CAI, Shanghai (CN); Huapin SHEN, Shanghai (CN); Chun Jie TONG, Shanghai (CN); Kai WEI, Shanghai (CN)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/874,119

(22) Filed: Oct. 17, 2007

(30) Foreign Application Priority Data
Oct. 18, 2006 (CN) 200610135550.X

(51) Int. Cl. G06F 17/30

(52) U.S. Cl. 707/6; 707/E17.014

(57) ABSTRACT

The present description provides a method and an apparatus of indicating content search results. According to an embodiment of the present description, provided is a method of indicating content search results, comprising: inputting a search keyword; searching a match of the keyword among displayed contents and determining a location of the match on a display screen; and generating a directional hint indicating the location. In one feature, the present description permits a user to find a match result more conveniently and quickly and thereby improve the user experience. Other embodiments are described and claimed.

### FIELD

The present description relates to the field of computers and more particularly, to a method and an apparatus for indicating content search results.

### RELATED APPLICATIONS

This application claims priority to Peoples Republic of China application Serial No. 200610135550.X, filed Oct. 18, 2006, and is incorporated by reference in its entirety.

### BACKGROUND

With the development of display technology, computer displays have become increasingly large, with more and more content displayed on a screen. For example, a large quantity of information is frequently simultaneously displayed on the homepage of many websites. During document editing, many lines of text may be displayed in an edit window. Furthermore, a page or edit window is sometimes divided into multiple boxes or sections with different boxes displaying different content, resulting in a complicated user interface. A user often resorts to a search tool in order to quickly find a desired or interesting part among a large quantity of displayed content. A search tool can locate the desired content by matching a user supplied keyword or other bookmark. Upon finding the matching content, the search tool usually highlights the content in reverse color to provide a hint to the user that the matching content has been found. However, when there is a large quantity of content being displayed whereas the matches highlighted in reverse color are relatively few, it is still often relatively difficult for the user to find the match. For example, FIG. 1 depicts a page 100 in which content including text and graphics is displayed. In this example, the user wishes to search the letter “s” on this page as indicated in the search input box 110. After the search tool finds the letter “s” and shows it in reverse color, it may be difficult for the user to find the part shown in reverse color. Thus, it can be difficult for the user to locate the matched letter “s.”

As another example as depicted in FIG. 2, the user inputs in an input field 200, the keywords of the address the user wants to search on a Google™ Map web page 210. The Web server searches in the database addresses matching the keyword the user has input and an associated map, and returns the associated map 220 to the user. In order to facilitate for the user the search for corresponding geographical locations, the locations of the addresses matching the keyword are indicated using a number of balloons 230 on the returned map 220.

### SUMMARY OF THE DESCRIPTION

According to one aspect of the present description, provided is a method of indicating content search results, comprising: inputting a search keyword; searching a match of the keyword among displayed contents and determining a location of the match on a display screen; and generating a directional hint indicating the location.

According to another aspect of the present description, provided is an apparatus for indicating content search results, comprising: an input module for inputting a search keyword; a search module for searching a match of the keyword among displayed contents and determining a location of the match on a display screen; and a control module for generating a directional hint indicating the location.

According to a further aspect of the present description, provided is an assembly for indicating content search results, comprising: an input module for inputting a search keyword; a search module for searching a match of the keyword among displayed contents and determining a location of the match on a display screen; and a control module for generating a directional hint indicating the location.

According to a still further aspect of the present description, provided is an article of manufacture, comprising at least one of a hardware device having hardware logic, and a computer readable memory having code, enabled to be executed by a system to perform operations, wherein the system has a display screen adapted to display contents, and wherein the operations comprise: inputting a search keyword; searching a match of the keyword among displayed contents and determining a location of the match on the display screen; and generating a directional hint indicating the location.

Other embodiments are described and claimed.

Other features and advantages of the present description will become apparent from the following description, when taken in conjunction with the accompanying drawings, in which like reference numerals designate the same or similar parts throughout the figures thereof.

### BRIEF DESCRIPTION ON THE DRAWINGS

The accompanying drawings, which constitute a part of the specification, illustrate embodiments of the description and, together with the description, serve to explain principles of the description.

FIG. 1 depicts a schematic view of a search for displayed contents in the prior art;

FIG. 2 depicts a schematic view of display of matches in the prior art;

FIG. 3 depicts a flowchart of a method of indicating content search results according to an embodiment of the present description;

FIG. 4 depicts a block diagram of an apparatus for indicating content search results according to an embodiment of the present description;

FIGS. 5-8 depict schematic views of user interfaces according to multiple embodiments of the present description; and

FIG. 9 schematically depicts a computer system in which embodiments of the present description can be implemented.

### DETAILED DESCRIPTION OF THE DRAWINGS

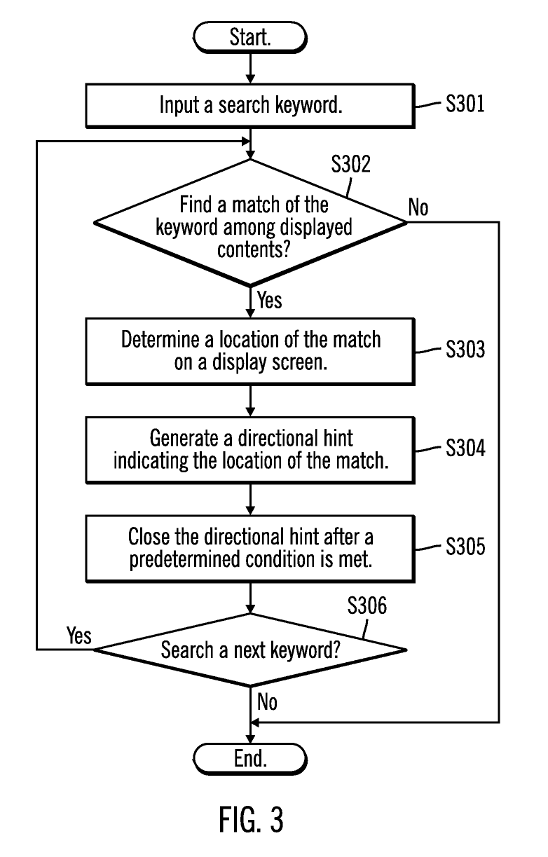

Referring to FIG. 3, a flowchart depicting a method of indicating content search results according to an embodiment of the present description, is shown. In one operation, a keyword of a particular search is input (block S301). A decision is made (block S302) as to whether or not content matching the keyword is found among displayed contents. If yes, the location of the match on the display screen is determined (block S303).

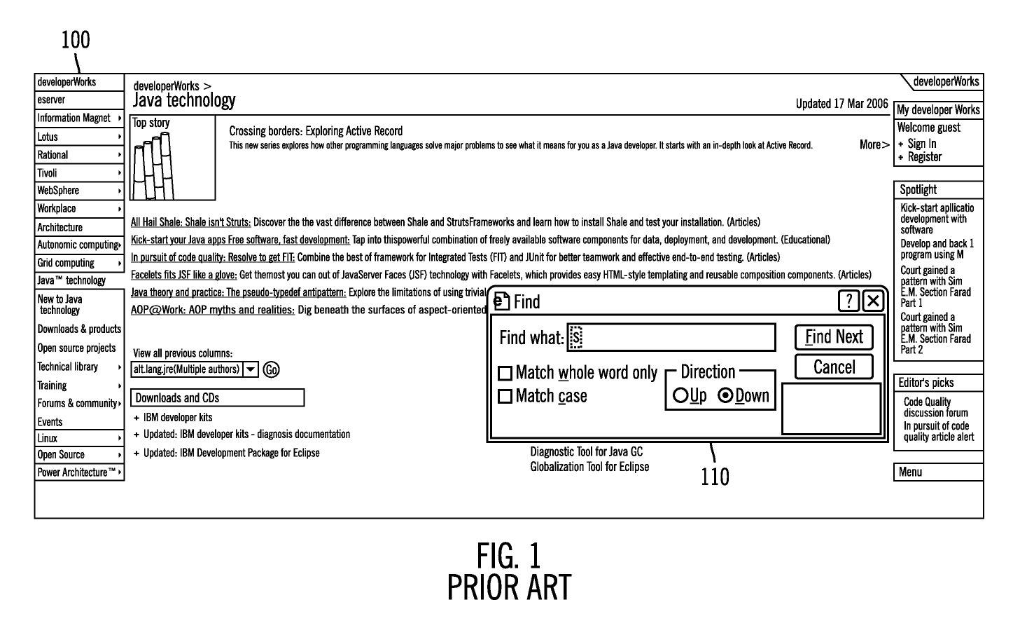

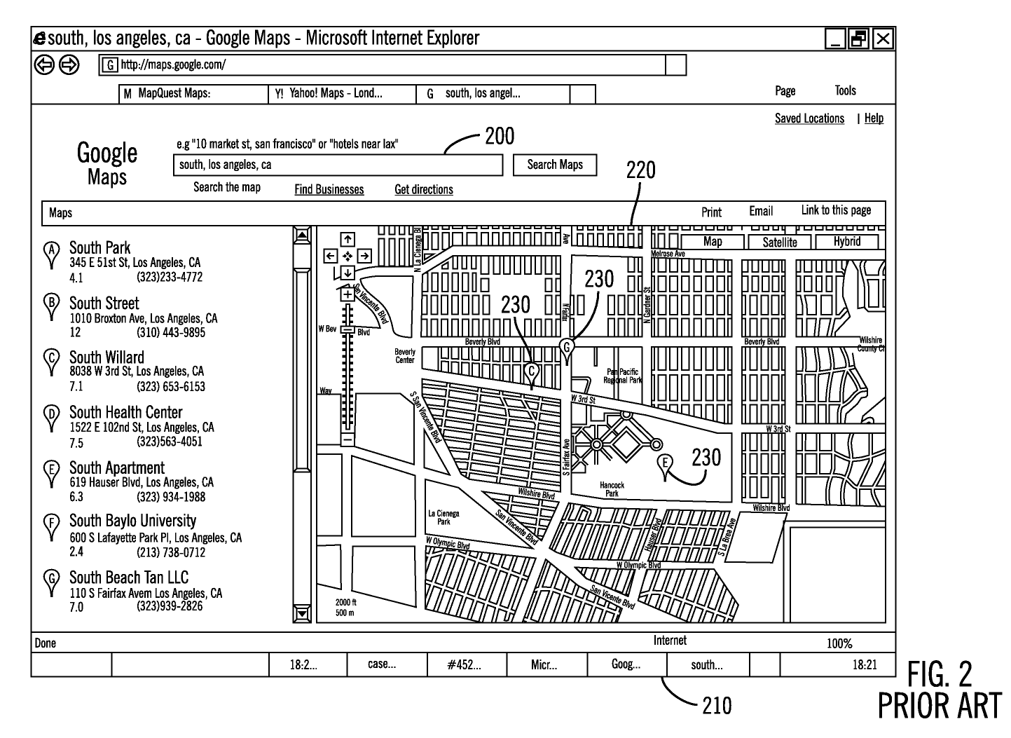

The above operations S301-S303 can be performed using any suitable search tool including those common search tools of the prior art. FIG. 1 depicts a schematic view of a search procedure in the prior art. For example, to search the letter “s” on a web page, a user opens a search dialog box 110 and inputs the keyword “s”. Then, the browser searches the first matched keyword “s”. Next, the match's location on the page is determined and shown in reverse color.

In accordance with one aspect of the present description, and providing an improvement over prior search tools, a directional hint for indicating the location of the match is generated (block S304). Since the location of the match has been found (block S303), an aural or visual directional hint or both can be generated in order to facilitate the finding of this location by the user. Following this hint, the user can find the match with relative ease, reducing or eliminating scanning of the whole screen or window for the part shown in reverse color or otherwise indicated with highlighted text.

In an embodiment of the present description, the directional hint is an aural directional hint. For example, upon finding a match, an audio segment can be played to indicate the location of the match. Such audio segment may be a prerecorded audio segment or a generated audio segment such as a voice-synthesized audio. For example, when the match is located in the direction of about 45 degrees or five o'clock in relation to the center of the screen or the current window, then the audio voice segment “in the direction of 45 degrees” or “in the direction of five o'clock” will be played. In this way, the user may search for the match directed to this direction. In another example, the screen or window may be divided into four or nine sections. Thus, upon finding of a match, audio indicating a corresponding area will be played in line with the area where the match is located. For example, after the audio segment “upper left section” is played, the user simply scans the upper left section for the contents shown in reverse color or otherwise highlighted.

It should be understood that other aural directional hints, such as nonvoice tones or combinations of tones in which the frequency, length, number of repetitions and the like, can be varied so as to indicate the location or direction of the match.

In another embodiment of the present description, the directional hint may be a visual directional hint, such as graphics, animation and the like, so as to indicate the location or direction of the match. For example, as depicted in FIG. 7, upon finding of a match, an arrow 700 directed to the direction of the match can be displayed on the search dialog box 710 which is overlayed over the content being displayed. Thus, by following the direction indicated by the direction of the arrow 700, the user's attention is directed to the match shown in reverse color or otherwise highlighted in the content being displayed. An additional hint for indicating the match may be provided by drawing a circle around the match. In this manner, the user can conveniently find the match shown in reverse color or otherwise highlighted in the drawn circle.

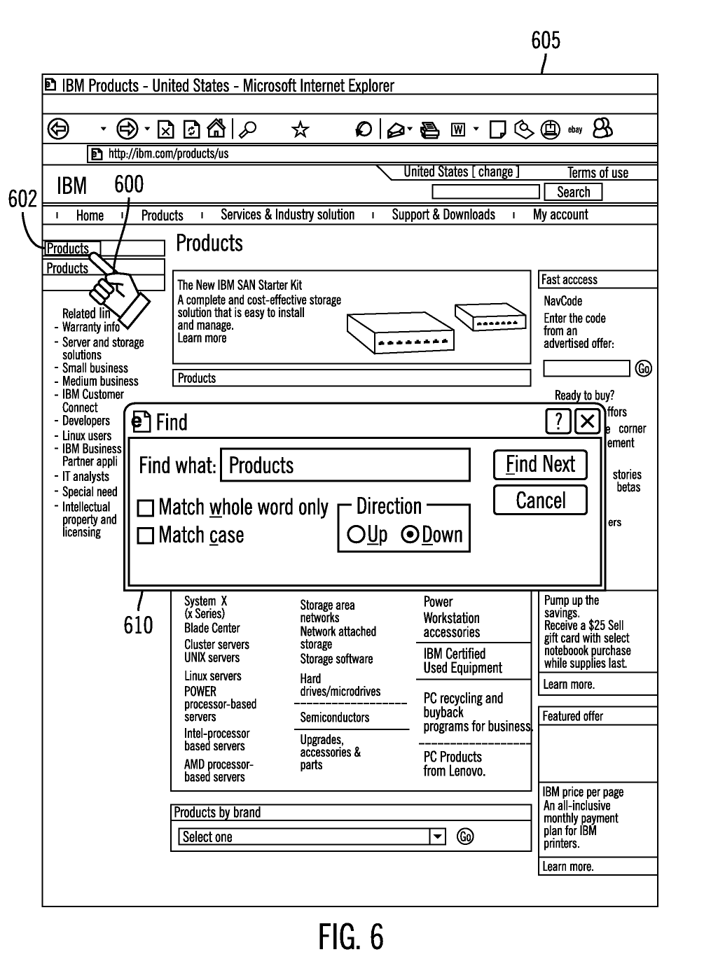

In another embodiment of the present description, the visual directional hint may be located wholly or partially outside the search dialog box. That is to say, in one embodiment, the end point of graphics, animation or other visual directional hint may be located near the match. For example, as depicted in FIG. 6, an arrow or finger graphics 600 directed to the direction of the match 602 within the displayed contents 605, will be displayed overlaying the contents 605 adjacent to the match 602 in order to provide a hint to the user as to the location of the match. Thus, in this embodiment, the visual directional hint 600 is located entirely outside the search dialog box 610. The displayed contents include text and graphics in this embodiment.

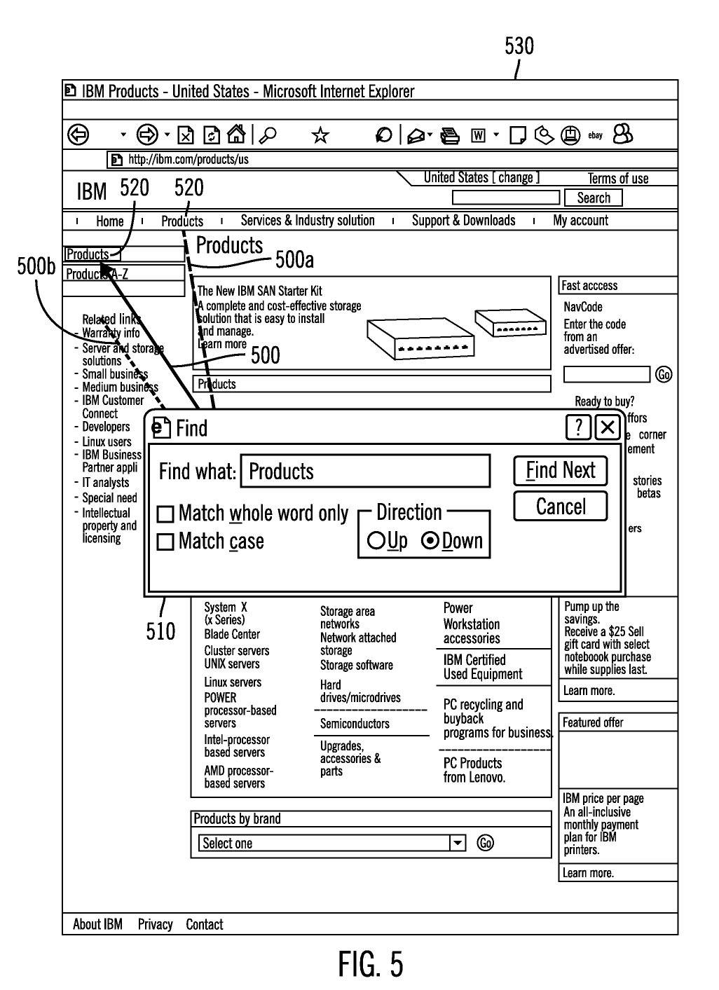

Additionally, when the user inputs the keyword, the user frequently concentrates on the search dialog box. Thus, the start point of the visual directional hint can be set on or at least adjacent to the search dialog box to better direct the user to find the location of the match. As depicted in FIG. 5, one or more arrows or other graphics 500 drawn from the search dialog box 510, overlaying the contents 530, and to or at least adjacent to the location or locations 520 of the matches within the displayed contents 530, can be displayed with the contents 530 in order to direct the user to find the match. In yet another example shown in FIG. 8, a more vivid manner is to display a segment of animation in which a bee, a spider man, or other graphic 800 is depicted “flying” or otherwise traveling from the search dialog box 810 to the location of the match within the displayed contents, so that the user can easily find the match.

In yet another embodiment, the start point of the visual directional hint may be provided at a fixed point on the screen. For example, every time a match is found, graphics may be displayed or a segment of animation may be played from the upper left corner or the center of the screen or the window, so as to indicate the direction of the match. It should be understood that this start point may change according to different conditions. For example, when the match is located at the leftmost side of the screen, if an arrow starting from the upper left corner is not conspicuous enough, then an arrow starting from the upper right corner may be drawn to point to the location.

The directional hint might interfere with or otherwise distract the user in some cases. Therefore, the directional hint may be closed (block S305, FIG. 3) after meeting a predetermined condition. For example, the hint may be closed only after the visual directional hint has been displayed for a predetermined length of time. In another example, the hint may be closed after the hint has blinked on and off for a predetermined number of times or after the audio segment has been played for a predetermined number of times. The condition, such as a predetermined length of time or a predetermined number of times, for example, can be set by the user or may be based on the conspicuousness of the hint. For example, a large and clear visual directional hint may be displayed for a relatively short time, whereas a smaller hint may be displayed for a relatively longer period of time.

Next, a decision is made (block S306) as to whether the user desires to search a next match. If yes, the flow returns to block S302 for another search. Thus, when there are multiple matches for the input keyword among the displayed contents, multiple directional hints can be generated in sequence.

In searches for which there are multiple matches for the input keyword among the displayed contents, locations of the multiple matches on the display screen can be simultaneously determined. At the same time, as shown in FIG. 5, for example, multiple visual directional hints 500, 500a, 500b pointing to the matches 520 may be displayed. Thus, the user can quickly find multiple matches.

It should be understood that in some embodiments, generation of a directional hint may be omitted when a predetermined condition is met. For example, the additional directional hint may be displayed only if the keyword or keywords the user has input are not lengthy, such that a match which is shown in reverse color is not already conspicuous. As another example, if the match location is near the focus where the user performs an input, such as, for example, very close to the search dialog box, the directional hint may not be displayed. It is appreciated however that the user can decide whether additional hints of such kind are needed.

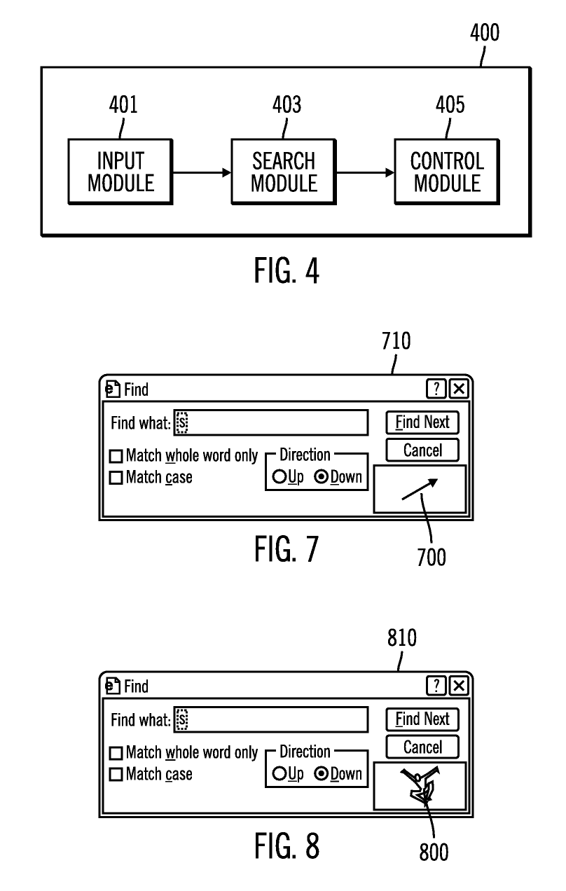

FIG. 4 depicts a block diagram of one example of an apparatus for indicating content search results in accordance the present description. An apparatus 400 for indicating content search results comprises an input module 401, a search module 403 and a control module 405. Input module 401 is used to input a search keyword. Search module 403 searches for a match for the keyword among the displayed contents and determines a location of the match on a display screen. Control module 405 generates a directional hint indicating the location of the match. Control module 405 causes the visual direction hint to be displayed on the display screen. Further, control module 405 can be used for deciding whether a predetermined condition is met, for generating an aural or visual directional hint after the predetermined condition is met, and for controlling various attributes of the directional hint, such as the number of the directional hints, start point, end point, number of repeats and the like. Still further, control module 405 can close the directional hint after a predetermined condition is met.

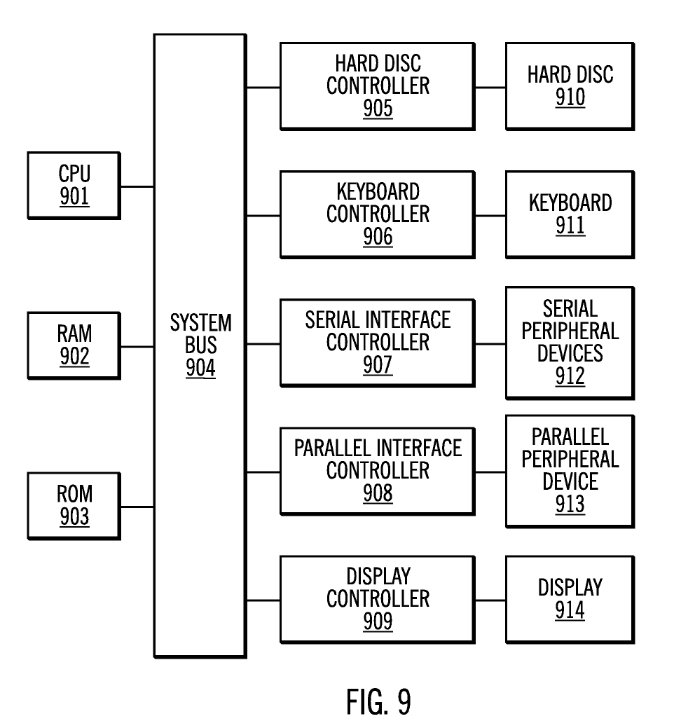

FIG. 9 schematically depicts a computer system in which embodiments of the present description can be implemented. The computer system as shown in FIG. 9 comprises: a CPU (central processing unit) 901, a RAM (random access memory) 902, a ROM (read-only memory) 903, a system bus 904, an HD (hard disc) controller 905, a keyboard controller 906, a serial interface controller 907, a parallel interface controller 908, a display controller 909, a hard disc 910, a keyboard 911, a serial peripheral device 912, a parallel peripheral device 913 and a display 914. Among these parts, connected with system bus 904 are CPU 901, RAM 902, ROM 903, HD controller 905, keyboard controller 906, serial interface controller 907, parallel interface controller 908 and display controller 909. Hard disc 910 is connected with HD controller 905, keyboard 911 is connected with keyboard controller 906, serial peripheral device 912 is connected with serial interface controller 907, parallel peripheral device 913 is connected with parallel interface controller 908, and display 914 is connected with display controller 909.

The basic function of each of the components in FIG. 9 is well known in the present technical field, and the hardware structure shown in FIG. 9 is also conventional. Such a structure may be applied to both personal computers and handheld devices, such as Palm PC, PDA (personal digital assistant), mobile phone and the like. Some components shown in FIG. 9 may be omitted in different applications. The entire system shown in FIG. 9 is controlled by computer readable instructions in accordance with the present description. The instructions may be stored as software in hard disc 910, EPROM or other non-volatile memory. The software may be downloaded from a network (not shown in the figure) or stored in hard disc 910. The software downloaded from a network may be uploaded to RAM 902 and executed by CPU 901, so as to perform the function determined by the software.

As the computer system shown in FIG. 9 is able to support the method of indicating content search results of the present description, the computer system merely serves as an example of computer systems. Those skilled in the art may understand that many other computer system designs are also able to carry out the embodiments of the present description.

The present description may further be implemented as a computer program product used by, for example the computer system shown in FIG. 9, which contains codes for implementing the method of indicating content search results according to the present description. The codes may be stored in a memory of other computer system prior to the usage. For instance, the codes may be stored in a hard disc or a removable memory like an optical disc or a soft disc, or may be downloaded via the Internet or other computer network.

The disclosed method and apparatus of the present description may be implemented in software, hardware or a combination of software and hardware. A hardware device may be implemented using dedicated logic, and a software part may be stored in a memory and be implemented by a proper instruction implementing system, such as a microprocessor, a personal computer (PC) or a mainframe. Thus, an apparatus in accordance with the present description may include an article of manufacture which includes code implemented in a computer readable memory, or hardware logic or a combination of such.

While the present description has been described with reference to what are presently considered to be the preferred embodiments, it is to be understood that the description is not limited to the disclosed embodiments. On the contrary, the description is intended to cover various modifications and equivalent arrangements included within the spirit and scope of the appended claims. The scope of the following claims is to be accorded the broadcast interpretation so as to encompass all such modifications and equivalent structures and functions.

What is claimed is:

1. A method of indicating content search results, comprising:
inputting a search keyword;
searching a match of the keyword among displayed contents and determining a location of the match on a display screen; and
generating a directional hint indicating said location.

2. The method in accordance with claim 1, wherein an aural directional hint is generated in said generating.

3. The method in accordance with claim 1, wherein a visual directional hint is generated in said generating.

4. The method in accordance with claim 3, wherein said visual directional hint is displayed on a search dialog box.

5. The method in accordance with claim 3, wherein said visual directional hint is at least one of graphics and animation whose end point is said location.

6. The method in accordance with claim 3, wherein a start point of said visual directional hint is on a search dialog box.

7. The method in accordance with claim 3, wherein a start point of said visual directional hint is a fixed point on a screen.

8. The method in accordance with claim 1, wherein multiple visual directional hints are generated in sequence upon finding of multiple matches.

9. The method in accordance with claim 3, wherein multiple visual directional hints are simultaneously displayed upon finding of multiple matches.

10. The method in accordance with claim 1, wherein said directional hint is generated after determining that a predetermined condition is met.

11. The method in accordance with claim 1, wherein said directional hint is closed after determining that a predetermined condition is met.

12. An apparatus, comprising:
a display screen adapted to display contents;
an input module adapted to input a search keyword;
a search module adapted to search for a match of the keyword among said displayed contents and determine a location of the match on said display screen; and
a control module adapted to generate a directional hint indicating said location.

13. The apparatus in accordance with claim 12, wherein said control module is adapted to generate an aural directional hint.

14. The apparatus in accordance with claim 12, wherein said control module is adapted to generate a visual directional hint and to cause said visual directional hint to be displayed on said display screen.

15. The apparatus in accordance with claim 14, wherein said display screen is adapted to display a search dialog box and said control module is adapted to cause said visual directional hint to be displayed on said search dialog box.

16. The apparatus in accordance 120
claim 14, wherein said visual directional hint is one of a graphics and animation, and has an end point which is at least adjacent said location.

17. The apparatus in accordance with claim 15, wherein said visual directional hint has a start point which is at least adjacent said search dialog box.

18. The apparatus in accordance with claim 14, wherein said visual directional hint has a start point at a fixed point on said display screen.

19. The apparatus in accordance with claim 12, wherein said control module is adapted to generate multiple directional hints in sequence when said search module finds multiple matches.

20. The apparatus in accordance with claim 14, wherein said control module causes said display screen to simultaneously display multiple directional hints when said search module determines multiple locations, each location corresponding to a match.

21. The apparatus in accordance with claim 12, wherein said control module is adapted to generate said directional hint after determining that a predetermined condition is met.

22. The apparatus in accordance with claim 12, wherein said control module is adapted to close said directional hint when a predetermined condition is met.

23. A search dialog box assembly, comprising:
an input module for inputting a search keyword;
a search module for searching a match of the keyword among displayed contents and determining a location of the match on a display screen; and
a control module for generating a directional hint indicating said location in the dialog box.

24. An article of manufacture, comprising at least one of a hardware device having hardware logic, and a computer readable memory having code, enabled to be executed by a system to perform operations, wherein the system has a display screen adapted to display contents, and wherein the operations comprise:
inputting a search keyword;
searching a match of the keyword among displayed contents and determining a location of the match on said display screen; and
generating a directional hint indicating said location.

25. The article in accordance with claim 24 wherein a visual directional hint is generated in said generating.
